(19) United States
(12) Patent Application Publication
(10) Pub. No.: US 2010/0022161 A1
(43) Pub. Date: Jan. 28, 2010

(54) Ideal Bee Hive Walls

(76) Inventor: Artem Shtatnov, Newtown, PA (US)

Correspondence Address: Artem Shtatnov, 154 Jericho Valley Drive, Newtown, PA, 18940, US

(21) Appl. No.: 12/509,447

(22) Filed: Jul. 25, 2009

Related U.S. Application Data
(60) Provisional application No. 61/083,704, filed on Jul. 25, 2008.

(51) Int. Cl. A01K 47/06; A01K 47/00

(52) U.S. Cl. 449/1; 449/29

(57) ABSTRACT

Beehive walls created by using a thin metallic sheet and insulation, separated by an air space in order to protect the bees from harmful electromagnetic waves, create a warm environment, and properly ventilate the hive. This will increase honey production throughout the year while providing a comfortable living environment. This method is both effective and affordable.

### BRIEF DESCRIPTION OF THE DRAWING

The four drawings show the wall structure claimed along with a possible beehive design for properly implementing this wall structure.

FIG. 1 gives a cross section of the wall with a metallic sheet 101 on the outside and a piece of insulation 103 on the inside. They are separated by an air space 102 which is formed when combined with the frame 108 illustrated in FIG. 3.

FIG. 2 shows the front view of the hive with lid, frame, and base separated.

FIG. 3 is a perspective view of the wood structure of the hive without the metal sheet and insulation to interfere.

FIG. 4 is a perspective view of the complete hive with lid, frame, and base slightly separated to show detail.

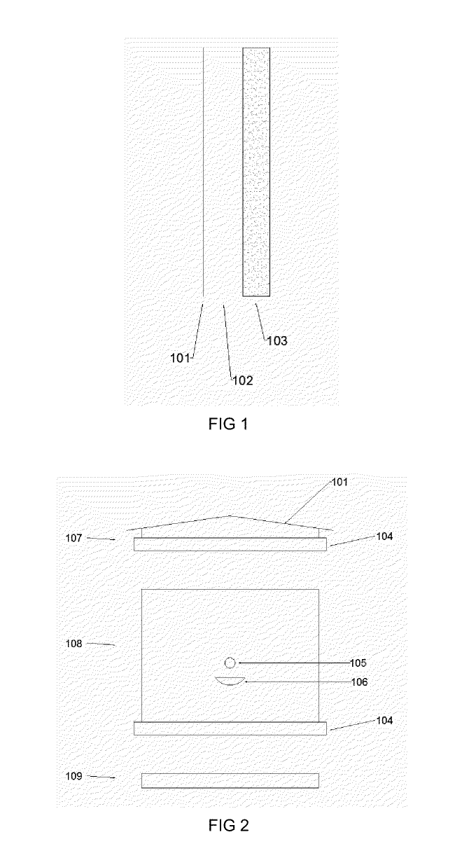

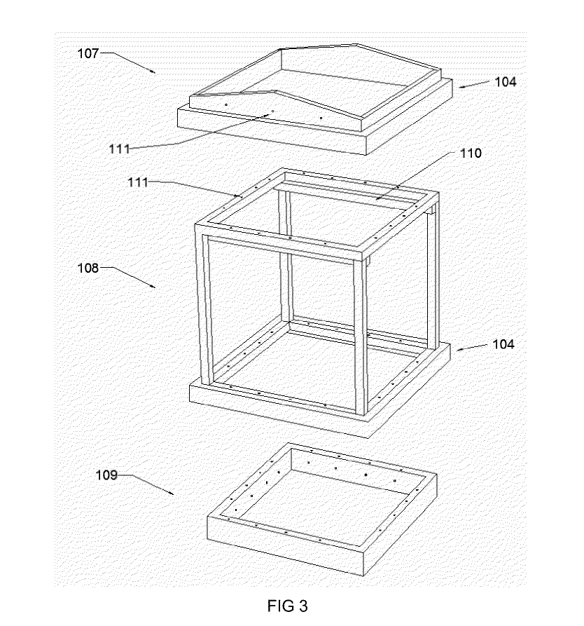

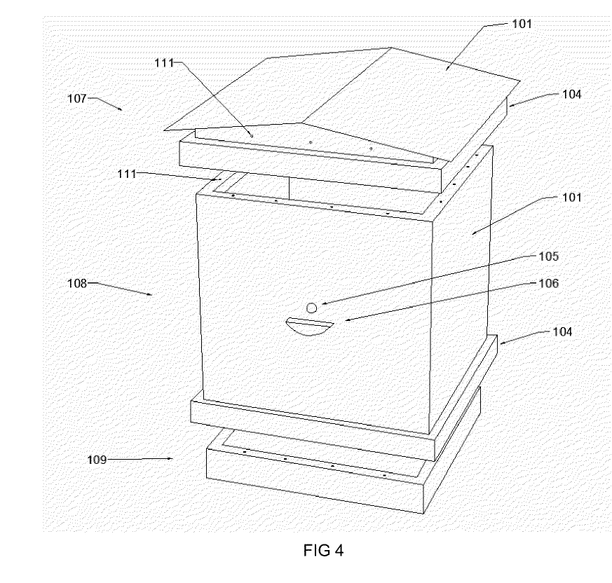

### DETAILED DESCRIPTION OF THE INVENTION

Beehive walls created by using a thin metallic sheet 101 and insulation 103, separated by an air space 102 in order to protect the bees from harmful electromagnetic waves, create a warm environment, and properly ventilate the hive. This will increase honey production throughout the year while providing a comfortable living environment. This method is both effective and affordable.

### Metal Sheet

The exterior wall of the beehive is a thin sheet of metal 101 such as aluminum that is used to insulate the hive from electromagnetic waves that can interfere with the bee's navigation system and prevent production of honey. This layer provides no structural support to the hive. This outer metal layer may be covered with a coating of nano-particles designed with nanotechnology to better protect the hive, both physically and against electromagnetic waves. The sheet of metal doesn't need to have structure. It may be sprayed on any material in a very thin layer in the scale of nanometers or micrometers. The main part is to create a Faraday cage type insulation for the bees inside. The front of the hive has a small hole 105 cut in the metal sheet so bees can enter the hive and a platform 106 directly below this hole for bees to use before entering the hive.

### Frame

The layer of metal is attached to the exterior of a wood frame 108 approximately half an inch thick. This frame provides the structural support for the hive and allows stacking of units on top of each other.

The frame includes two wood beams 110, one spanning each side and slightly protruding towards the inside of the hive, to hang standard sized wire panes to assist the bees in creating the honeycomb.

The lower portion of the frame has a wooden extrusion 104 along all four sides protruding slightly below the frame and on the outside of the frame to provide lateral support when stacking.

This wooden frame acts as a separating layer to create air space between the insulation and metal sheet. The air space allows moisture to escape the beehive and provide additional insulation. This frame has holes 111 drilled in it to allow the moisture to escape.

### Insulation

A layer of insulation 103 is attached to the inside of the frame but has no contact with the metal sheet. This layer provides warmth to the bees while allowing moisture to escape through it. It may be made up of any sort of solid state material that holds its form. The insulation provides no structural support but is in contact with the bees so must be sturdy and non toxic. This layer of insulation can be made from nano-foam to increase its ability to transfer moisture away from the inside of the beehive to provide a low humidity environment for the bees. A second layer of non-porous insulation may be attached to the outer metal sheet for additional insulation.

### Base

The base 109 is detachable from the main beehive unit and is simply comprised of two square wooden frames with a strong piece of cloth between them to separate the hive from the ground. The main unit is design to easily be placed on top of the base. There is a small amount of air space between the main unit and the cloth or insulation of the frame. There is also air space under the cloth and above the lowest portion of the base. These two air spaces are the thickness of the wood used to build the base. The base is designed to be placed on risers such as concrete blocks or any other sturdy material that allows air to flow under the base.

### Lid

The lid 107 of the beehive is created with a wood frame the same shape and size as the main beehive unit to be placed on top of the beehive. The frame also includes a wood protrusion 104 along all outer sides to provide lateral support when placed on the main beehive unit.

The top of the lid frame is covered with a slanted sheet of metal that acts to both protect the hive from the elements and insulate the bees from electromagnetic waves. This metal sheet slightly extends over all four sides of the hive.

The lid frame includes small air holes 111 along all sides. These holes are close to the metal roof to prevent rain from entering the hive while allowing ventilation. The holes are too small for any animals or birds to enter.

The lid is placed on top of the main beehive unit but not before a sheet of cloth is laid on the uppermost hive unit. This sheet of cloth prevents the bees from entering the lid area.

### Benefits of this Design

This type of wall design, when properly implemented in a hive as described above, creates a variety of benefits over a standard beehive. Its main advantages are as follows:
1. Protect the bees from harmful electromagnetic waves.
2. Create a warm living environment that is properly ventilated.
3. Increase honey production throughout the year.
4. Cost efficient and easy to implement.

What is claimed is:

1. A wall used for beehives comprising a thin sheet of metal, air space, and insulation;

2. The utility of claim 1 where said insulation can be any sort of foam or nano-foam;
